(19) United States
(12) Patent Application Publication
(10) Pub. No.: US 2024/0077235 A1
(43) Pub. Date: Mar. 7, 2024

(54) REFRIGERATION PLANT AND METHOD FOR OPERATING A REFRIGERATION PLANT

(71) Applicant: LAUDA DR. R. WOBSER GMBH & CO. KG, Lauda-Königshofen (DE)

(72) Inventor: Alfred Semrau, Grünsfeld (DE)

(73) Assignee: LAUDA DR. R. WOBSER GMBH & CO. KG, Lauda-Königshofen (DE)

(21) Appl. No.: 18/241,562

(22) Filed: Sep. 1, 2023

(30) Foreign Application Priority Data
Sep. 6, 2022 (DE) 10 2022 122 589.5

(51) Int. Cl. F25B 9/00; F17C 5/00; F25B 9/10

(52) U.S. Cl. CPC F25B 9/004; F17C 5/00; F25B 9/10; F17C 2221/012; F17C 2227/0355; F17C 2265/065; F25B 2600/111; F25B 2600/2515; F25B 2700/1931; F25B 2700/2103; F25B 2700/2106

(57) ABSTRACT

A refrigeration plant (100) for cooling a target fluid to a target temperature between −80° C. and +30° C. by means of ambient air, having a compressor refrigerant system (105) having a compressor (125) and a target heat exchanger (120) for cooling the target fluid; a natural circulation refrigerant system (140) having an ambient air condenser (145) and a control valve (165), and an intermediate heat exchanger (120) which couples the natural circulation refrigerant system (140) to the compressor refrigerant system (105).

### BACKGROUND OF THE INVENTION

The invention relates to a refrigeration plant and a method for operating a refrigeration plant.

In filling stations which provide hydrogen for filling motor vehicles, the hydrogen has to be cooled. In refrigeration plants from the prior art, at low external temperatures the pressure in the refrigerant-carrying systems may drop or when the compressor of the refrigeration machine is started not be built up at all.

In order to solve this problem, condenser pressure regulators may bring about an accumulation of condensate in the air-cooled condenser in order to reduce the free face of the heat exchanger. This conventional type of power limitation is comparatively expensive and requires increased quantities of refrigerant in order to enable the accumulation. This type of power limitation involves higher costs and additional disadvantages in the form of environmental pollution and with flammable refrigerants a higher risk and fire load. Another problem with significant quantities of refrigerant may be a displacement of significant quantities of refrigerant into the lubricant oil of the compressor.

### SUMMARY OF THE INVENTION

An object of the invention is to improve known refrigeration plants, in particular a quantity of refrigerant used should be minimized, the process cooling unit should have good starting properties even at comparatively low external temperatures and a refrigerant displacement into the lubricating oil of the compressor should be minimized and an energy efficiency be improved as far as possible.

The object is achieved with a refrigeration plant as disclosed herein and with a method also as disclosed herein. Advantageous further developments and embodiments will be appreciated from the dependent claims and from this description.

A first aspect of the invention relates to a refrigeration plant, in particular for cooling a target fluid to a target temperature between −80° C. and +30° C. by means of ambient air, comprising: a compressor refrigerant system having a compressor and a target heat exchanger for cooling the target fluid; further comprising a natural circulation refrigerant system having an ambient air condenser and a control valve, and having an intermediate heat exchanger which couples the natural circulation refrigerant system to the compressor refrigerant system.

Another aspect of the invention relates to a method for cooling a target fluid to a target temperature of at least −80° C., at least −60° C. or at least −45° C. or a maximum of +30° C., a maximum of −10° C. or a maximum of −35° C. by means of ambient air using a refrigeration plant in one of the typical embodiments described herein.

The refrigeration plant is typically configured to be operated at ambient air temperatures of at least up to −40° C. or at least up to −20° C.

The operating fluid in the compressor refrigerant system is also referred to in this instance as compressor refrigerant. In addition, lubricant oil for the compressor is also located in the compressor refrigerant system and is in a mixing equilibrium with the compressor refrigerant. In the compressor refrigerant systems, both conventional fluorinated gases (F-gases), such as, for example, R-449A and “natural” refrigerants, such as, for example, CO₂ (R-744) or propane (R-290)/propene (R-1270) are used as an operating fluid.

After the compressor, an intermediate heat exchanger is typically interposed as a condenser of the compressor refrigerant. In typical embodiments, this intermediate heat exchanger is arranged at the so-called cold side of the natural circulation refrigerant system. It typically thermally connects the compressor refrigerant system to the natural circulation refrigerant system. The respective refrigerants of the refrigerant systems typically remain separated.

The operating fluid located in the natural circulation refrigerant system is also referred to herein as natural circulation refrigerant. In the natural circulation refrigerant system, both conventional fluorinated gases (F-gases), such as, for example, R-449A, and “natural refrigerants”, such as, for example, CO₂ (R-744) or propane (R-290)/propene (R-1270) can be used as an operating fluid. If possible, the same operating fluid as in the compressor refrigerant system can be used, this prevents the risk of confusion and simplifies storage and maintenance. Technically, however, it is also possible to use different operating fluids, for example, in order to improve an efficiency of embodiments.

Typically, the compressor refrigerant system comprises a pressure sensor for establishing a pressure of a compressor refrigerant which is located in the compressor refrigerant system. The pressure sensor is arranged downstream of the compressor, between the compressor and the intermediate heat exchanger. For example, the pressure sensor establishes the pressure of the compressor refrigerant directly after the compressor or at an inlet of the intermediate heat exchanger. The pressure sensor establishes the pressure at which the compressor compresses the compressor refrigerant. The pressure may correspond to the condensation pressure of the compressor refrigerant. Typically, the degree of opening of the control valve is controlled in such a manner that the measured pressure is controlled to the condensation pressure or a target condensation pressure. The value of the target condensation pressure is dependent inter alia on the refrigerant used and may be, for example, for propane (R-290)/propene (R-1270) between 8 and 22 bar or for CO₂ (R-744) between 80 and 280 bar.

As a result of the target heat exchanger, the cooling power of the compressor refrigerant system is free, the used refrigerant power corresponds to a useful cooling power of the refrigeration plant. The condensation pressure of the compressor refrigerant is dependent on a required useful cooling power of the compressor refrigerant system. Typically, the compressor refrigerant system comprises a throttle valve. The useful cooling power can be increased or decreased by more or less compressor refrigerant being injected into the target heat exchanger by the throttle valve. For example, in response to a refrigerant request, by opening the throttle valve which controls the supply to the target heat exchanger, more compressor refrigerant can be injected. If more compressor refrigerant is injected into the target heat exchanger, as a result of the continuous circulation in the compressor refrigerant system of the compressor, more compressor refrigerant is compressed. The compressor refrigerant discharges exchange heat in the intermediate heat exchanger and is condensed. If more compressor refrigerant is compressed by the compressor, with the exchange heat remaining consistent the compressed compressor refrigerant is only partially liquefied and there is an accumulation of the compressor refrigerant upstream of the intermediate heat exchanger. The condensation pressure of the compressor refrigerant increases. In order to keep the condensation pressure of the compressor refrigerant constant, a power of the intermediate heat exchanger can be increased in order to discharge more exchange heat, whereby more compressor refrigerant is liquefied. In particular, the condensation pressure can be kept constant at a target condensation pressure.

In typical embodiments, a refrigeration plant as described herein comprises a control valve, wherein the control valve is configured in a supply line of the natural circulation refrigerant system to the intermediate heat exchanger so that the supply or a mass flow of the natural circulation refrigerant to the intermediate heat exchanger can be controlled. In particular, the supply can also be controlled up to zero. A quantity of thermal energy, in particular the exchange heat, which can be discharged by the compressor refrigerant in the intermediate heat exchanger to the natural circulation refrigerant is dependent on the mass flow of the natural circulation refrigerant in the intermediate heat exchanger. The control valve can therefore control the exchange heat. In typical refrigeration plants, the control valve can be configured to control a mass flow of the natural circulation refrigerant in the intermediate heat exchanger using the signal of the pressure sensor in such a manner that the condensation pressure of the compressor refrigerant is kept at least substantially constant.

In typical embodiments, the control valve controls the supply by an opening degree of the control valve. In typical embodiments, an opening extent of the control valve can be controlled in order to influence the degree of opening. In typical embodiments, the control valve can be operated in pulse mode in order to influence the degree of opening.

In a typical refrigeration plant, the ambient air condenser comprises a fan. The fan is typically configured to convey ambient air through the condenser in order to increase a cooling power of the ambient air condenser. In particular, a cooling power can be increased or controlled by a speed of the fan being increased or controlled.

The ambient air condenser is typically arranged upstream of the intermediate heat exchanger. The natural circulation refrigerant absorbs in the intermediate heat exchanger the exchange heat of the compressor refrigerant and flows to the ambient air condenser. The natural circulation refrigerant discharges thermal energy to the ambient air in the ambient air condenser.

In typical embodiments of the refrigeration plant, the ambient air condenser is positioned higher than the intermediate heat exchanger. In particular, the ambient air condenser is arranged in such a manner that the natural circulation refrigerant system forms a thermosiphon. The ambient air condenser has a vertical height difference with respect to the intermediate heat exchanger in typical embodiments. The height difference is typically at least 0.5 m or at least 1 m. Liquid natural circulation refrigerant absorbs the exchange heat in the intermediate heat exchanger. With a consistent temperature, in particular with a consistent condensation temperature, the exchange heat is transmitted from the compressor refrigerant to the natural circulation refrigerant. As a result of the absorption of the exchange heat, the liquid natural circulation refrigerant changes to a gaseous state. The density difference between the liquid and gaseous natural circulation refrigerant leads to the gaseous natural circulation refrigerant rising upstream upward to the ambient air condenser. In the ambient air condenser, the natural circulation refrigerant discharges thermal energy and is liquefied. The liquid natural circulation refrigerant flows downstream to the intermediate heat exchanger and the operation of the thermosiphon begins again. The operation of the thermosiphon is driven by the exchange heat. The natural circulation is maintained for as long as energy is supplied to the natural circulation refrigerant system via the intermediate heat exchanger and there is a positive temperature difference between the condensation temperature of the compressor refrigerant system and the ambient air temperature.

In typical refrigeration plants, the natural circulation refrigerant system has a parallel-connected refrigerant system comprising: a parallel-connected heat exchanger for cooling the target fluid and a parallel-connected control valve for controlling the supply flow to the parallel-connected heat exchanger. The parallel-connected refrigerant system is typically connected to the same ambient air condenser of the natural circulation refrigerant system. The refrigerant in the parallel-connected refrigerant system is typically the same refrigerant as the refrigerant in the natural circulation refrigerant system.

The parallel-connected refrigerant system can be used in embodiments to cool the target fluid of the system which is intended to be cooled by ambient air. This cooling using ambient air corresponds to a free cooling. A cooling via the parallel-connected refrigerant system, typically when a sufficiently large positive temperature difference is present, can increase the overall degree of efficiency of the refrigeration plant. Always when, for example, for a minimum time period which has to be determined, a usable temperature difference occurs between the target temperature of the target fluid and the ambient air temperature, wherein the ambient air temperature is less than the target temperature, switching is advantageously carried out to free cooling, that is to say, to cooling via the parallel-connected system.

In parallel with the compact refrigerant condenser, a parallel-connected heat exchanger is incorporated. If a potential advantageous operating method via free cooling is detected by the control system, the compressor refrigerant system is switched off and, via a valve switching or a series connection, the target fluid which is intended to be cooled is directed through the parallel-connected cooler. The operating principle is similar to that described above for the intermediate heat exchanger. The warmer medium, for example, target fluid which is intended to be cooled, discharges its heat to the evaporating natural circulation refrigerant of the natural circulation refrigerant system. At a consistent temperature, in particular at a consistent evaporation temperature, the heat is absorbed by the saturated steam of the natural circulation refrigerant system.

In typical embodiments, the parallel-connected control valve is configured in such a manner that it controls the supply of the natural circulation refrigerant from the natural circulation refrigerant system into the parallel-connected refrigerant system. The parallel-connected control valve typically controls a mass flow of the natural circulation refrigerant into the parallel-connected heat exchanger. A quantity of thermal energy which can be discharged from the target fluid in the parallel-connected heat exchanger to the natural circulation refrigerant is also dependent on the mass flow of the natural circulation refrigerant in the parallel-connected heat exchanger. The control valve can in this manner control the parallel-connected exchange heat. Furthermore, the quantity of thermal energy which can be discharged from the target fluid in the parallel-connected heat exchanger to the natural circulation refrigerant is dependent on a quantity of thermal energy which the natural circulation refrigerant in the ambient air condenser can discharge to the ambient air. In typical embodiments, the speed of the fan of the ambient air condenser can be controlled in accordance with a required parallel-connected exchange heat.

Typically, the natural circulation refrigerant system is configured in such a manner that a maximum of one of the control valve and parallel-connected control valve is opened. In particular, the natural circulation refrigerant system is configured in such a manner that during operation either the control valve is opened and the parallel-connected control valve is closed, or vice versa. Typically, the control valve is configured in such a manner that, when a limit temperature difference of the difference between the target temperature and ambient air temperature is exceeded, wherein the target temperature is greater than the ambient air temperature, the control valve is closed. In embodiments, the limit temperature difference is at least 5 K. Typically, the limit temperature difference is at least 10 K.

In typical embodiments of a refrigeration plant as described herein, the ambient air condenser is arranged higher than the parallel-connected heat exchanger. In particular, the ambient air condenser is arranged in such a manner that the parallel-connected refrigerant system forms a thermosiphon. In typical embodiments, the ambient air condenser has a vertical height difference with respect to the parallel-connected heat exchanger. The height difference is typically 0.5 m or 1 m. The height difference is selected in such a manner that a circulation without any pump is produced. In particular, the height difference is selected in such a manner that a thermosiphon is produced, for example, as described above in a similar manner for the natural circulation refrigerant system.

In the event of a cold start of the refrigeration plant, in particular in the case of cold ambient air, the control valve and the parallel-connected control valve are typically closed. The compressor compresses compressor refrigerant in the compressor refrigerant system, whereby the compressor refrigerant becomes heated. The compressor refrigerant discharges thermal energy to potentially cold pipelines and the cold intermediate heat exchanger, whereby the compressor refrigerant is condensed. The pipelines and the intermediate heat exchanger become heated as a result of the absorption of the thermal energy.

Prior to the cold start, in embodiments natural circulation refrigerant can be removed from the intermediate heat exchanger, for example, by means of accumulation in the ambient air condenser. As a result, the intermediate heat exchanger can become heated even more quickly so that in the natural circulation refrigerant system energy is built up for a circulation of the natural circulation refrigerant. Alternatively, a discharge of the intermediate heat exchanger can be dispensed with, for example, since the intermediate heat exchanger is comparatively compact and nonetheless absorbs only a small quantity of natural circulation refrigerant.

After the condensation pressure has risen and the throttle valve has been opened, the compressor refrigerant is injected via the throttle valve into the target heat exchanger. The compressor refrigerant system comes into operation. The control valve is opened and the intermediate heat exchanger discharges exchange heat to the natural circulation refrigerant system. The condensation pressure of the compressor refrigerant can now be controlled via the degree of opening of the control valve. The degree of opening of the control valve influences the quantity of heat transmitted in the intermediate heat exchanger.

Since the internal compact intermediate heat exchanger has little mass and content of natural circulation refrigerant, the plant in the case of an interrupted natural circulation refrigerant system rises very quickly to the required operating pressure and the compressor refrigerant system can more rapidly discharge full useful cooling power. This is almost independent of the ambient air temperature.

Typical methods for cooling a target fluid comprise, for starting the refrigeration plant, the following steps which are carried out in particular in the sequence set out: closing the control valve and closing the parallel-connected control valve; switching on the compressor in order to compress the compressor refrigerant so that the intermediate heat exchanger is heated by means of the compressor refrigerant; establishing a pressure of the compressor refrigerant downstream of the compressor and upstream of the intermediate heat exchanger; comparing the pressure with a target pressure; and opening the control valve when the pressure of the compressor refrigerant reaches the target pressure. The term “reach” in this instance is also intended to include exceeding. When the plant comes to a standstill, the control valve and the parallel-connected control valve can be closed. When the control valve and the parallel-connected control valve are closed prior to starting the refrigeration plant, they are kept closed. The pressure may correspond to the condensation pressure of the compressor refrigerant. The target pressure may correspond to the target condensation pressure of the compressor refrigerant.

Typically, methods as described herein comprise opening the control valve until an opening degree of the control valve reaches a first limit value, wherein the opening degree is dependent on the condensation pressure. In particular, the control valve is opened in accordance with the condensation pressure in order to keep the condensation pressure of the compressor refrigerant as measured at the pressure sensor constant. Typically, the first limit value is less than a 70% degree of opening or less than an 80% degree of opening. In order to increase the useful cooling power of the refrigeration plant, more compressor refrigerant has to be injected into the target heat exchanger.

In order to increase the useful cooling power of the refrigeration plant, the throttle valve is typically opened further in order to inject more compressor refrigerant into the target heat exchanger. Since more compressor refrigerant is injected into the target heat exchanger, more compressor refrigerant is compressed by the compressor. If the exchange heat remains consistent, only a portion of the compressed compressor refrigerant becomes liquefied and there is an accumulation of the compressor refrigerant upstream of the intermediate heat exchanger. The condensation pressure of the compressor refrigerant between the compressor and the intermediate heat exchanger increases. In order to keep the condensation pressure constantly at the target condensation pressure, in the intermediate heat exchanger more exchange heat must be discharged from the compressor refrigerant to the natural circulation refrigerant. More compressor refrigerant is thereby liquefied. In particular, in order to ensure a continuous circulation, the exchange heat can be increased in such a manner that, in the intermediate heat exchanger, at least as much compressor refrigerant is liquefied as is injected into the target heat exchanger via the throttle valve.

By increasing the degree of opening of the control valve, the mass flow of the natural circulation refrigerant increases in the intermediate heat exchanger and more exchange heat can be transmitted. By increasing the degree of opening of the control valve, the useful cooling power of the refrigeration plant can be increased.

Furthermore, the method, for example, after reaching the first limit value or generally, may comprise controlling a speed of a fan of the ambient air condenser, for example, at a maximum up to a limit speed, wherein the speed is dependent on the condensation pressure. By increasing the speed of the fan, more ambient air flows through the fan and more exchange heat can be discharged or the condensation pressure can be lowered. The speed of the fan is controlled in order to keep the condensation pressure, for example, as constant as possible or as low as possible. In this manner, a deterioration of the efficiency as a result of excessively high condensation pressure or exceeding the permissible condensation pressure can be avoided.

After reaching the limit speed, the method may further comprise: increasing the degree of opening of the control valve up to a second limit value. The second limit value may be up to a 100% degree of opening. By increasing the degree of opening, the mass flow of natural circulation refrigerant in the intermediate heat exchanger is increased and more exchange heat can be discharged. By increasing the degree of opening of the control valve, the useful cooling power of the refrigeration plant can be increased.

If the condensation pressure of the compressor refrigerant is reduced, for example, if less useful cooling power of the refrigeration plant is required, the degree of opening of the control valve can first be reduced up to the first degree of opening. Subsequently, the speed of the fan can be decreased until the fan stops. Lastly, the degree of opening of the control valve can be decreased up to 0%. In another alternative, the speed of the fan can first be decreased and subsequently the degree of opening of the control valve can be reduced up to 0%.

In typical methods, the following steps are included in the sequence set out: in a first power range of the refrigeration plant, opening, in accordance with the condensation pressure of the compressor refrigerant, the control valve until a degree of opening of the control valve reaches a first limit value; in a second power range of the refrigeration plant, increasing, in accordance with the condensation pressure of the compressor refrigerant, a cooling power of the ambient air condenser; and, in a third power range, opening, in accordance with the condensation pressure of the compressor refrigerant, the control valve until the degree of opening reaches a second limit value, wherein the first limit value is less than a 70% degree of opening and the second limit value is up to a 100% degree of opening, wherein a useful cooling power of the refrigeration plant in the first power range is less than in the second power range and a useful cooling power of the refrigeration plant in the second power range is less than in the third power range.

Typical methods as described herein comprise closing the control valve and opening the parallel-connected control valve when a limit temperature difference which represents the difference between the target temperature and the ambient air temperature has been exceeded. For example, at a target temperature of +20° C. at an ambient air temperature of a maximum of +10° C., a use of the parallel-connected refrigerant system may be provided. By opening the parallel-connected control valve with a sufficient temperature difference between the target temperature and the ambient air temperature, the target fluid is cooled via the parallel-connected refrigerant system. The degree of efficiency of the refrigeration plant is thereby increased.

Typical methods as described herein include controlling the mass influx of the natural circulation refrigerant from the natural circulation refrigerant system into the parallel-connected refrigerant system by controlling the parallel-connected control valve. In particular, the mass influx can be controlled in accordance with a cooling requirement. By controlling the mass influx, a parallel-connected cooling power of the parallel-connected refrigerant system can be controlled.

Typical methods as described herein comprise: controlling the control valve so that the supply of the natural circulation refrigerant in the natural circulation refrigerant system to the intermediate heat exchanger is controlled. In particular, the mass influx can be controlled in accordance with the required exchange heat.

As a result of the two refrigerant systems, little flammable refrigerant is used and the process refrigeration unit can also be quickly started up at low ambient temperatures. A refrigerant displacement from the condenser into the lubricant oil of the compressor is minimized so that long service-lives and robust operation are ensured.

A use of the condenser as a free cooler is possible in typical embodiments. As a result of the use of the condenser as a free cooler, the energy efficiency of the plant is increased as a yearly average. The use of the condenser as a free cooler can be implemented in embodiments with little additional expenditure. The use of the condenser as a free cooler is particularly advantageous at low ambient air temperatures.

In typical embodiments, only the compressor refrigerant system or the compressor refrigerant are in contact with the lubricant oil. The natural circulation refrigerant system and the natural circulation refrigerant are typically not in contact with the lubricant oil or the compressor. The compressor refrigerant system has a filling quantity of refrigerant which is typically lower than the prior art. As a result of the two refrigerant systems, a thermal decoupling of the compressor refrigerant system from the natural circulation refrigerant system can be carried out. Since no condensate accumulation is required, in the air-cooled natural circulation refrigerant system, in typical embodiments, less refrigerant is also required. In refrigeration plants as described herein, no additional air-cooled heat exchanger is required. In particular, the air-cooled heat exchangers are material-intensive components and have larger dimensions. With refrigeration plants as described herein, both material and space are saved.

### BRIEF DESCRIPTION OF THE DRAWINGS

The invention is explained in greater detail below with reference to the appended drawings, in which:

FIG. 1 shows a schematic illustration of a refrigeration plant as described herein,

FIG. 2 shows a typical method for cooling a target fluid using a typical refrigeration plant described herein,

FIG. 3 shows a typical method for cooling a target fluid using a typical refrigeration plant described herein with free cooling.

### DETAILED DESCRIPTION

Typical embodiments of the invention will be described below with reference to the Figures, wherein the invention is not limited to the exemplary embodiments, instead the scope of the invention is determined by the claims.

In the description of the embodiments, in various Figures and for different embodiments, the same reference numerals may be used for identical or similar components. Sometimes features which have already been described in connection with other Figures are not mentioned or described multiple times for reasons of clarity.

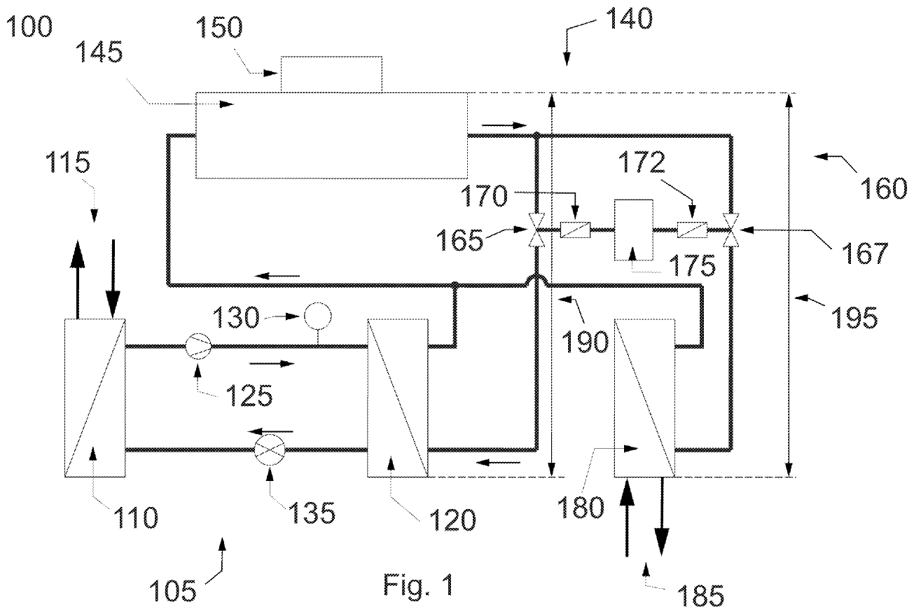

In FIG. 1, an exemplary embodiment of a refrigeration plant 100 is schematically illustrated. The refrigeration plant 100 comprises a compressor refrigerant system 105. The refrigeration plant 100 is configured to cool a target fluid to a target temperature. The target fluid is cooled with a useful cooling power 115 of the refrigeration plant. The target fluid may be cooled to a target temperature between −80° C. and +30° C., in particular to −40° C. In embodiments, the target fluid may be hydrogen.

The compressor refrigerant system comprises a target heat exchanger 110. The target heat exchanger 110 is connected at the cold side to the compressor refrigerant system. At the cold side, a compressor refrigerant of the compressor refrigerant system flows through the target heat exchanger. The target heat exchanger 110 is connected to the system to be cooled at the hot side. Target fluid of the system which is intended to be cooled flows through the target heat exchanger 110 at the hot side. In the target heat exchanger, the compressor refrigerant absorbs thermal energy from the target fluid.

The refrigeration plant 100 comprises an intermediate heat exchanger 120. The intermediate heat exchanger 120 is connected to the compressor refrigerant system 105 at the hot side and is flowed through by the compressor refrigerant. At the cold side, the intermediate heat exchanger 120 is connected to a natural circulation refrigerant system 140 and is flowed through by a natural circulation refrigerant. The compressor refrigerant discharges in the intermediate heat exchanger 120 thermal energy to the natural circulation refrigerant and condenses.

The compressor refrigerant system comprises downstream of the target heat exchanger a compressor 125 which compresses the compressor refrigerant after it has absorbed thermal energy of the target fluid in the intermediate heat exchanger. A pressure sensor 130 is arranged downstream of the compressor 125 and establishes a pressure of the compressor refrigerant. The data of the pressure sensor 130 may be able to be read electronically, in particular the pressure sensor 130 may be integrated in a control circuit.

A throttle valve 135 is arranged downstream of the intermediate heat exchanger. The compressor refrigerant is liquefied in the intermediate heat exchanger and reaches the throttle valve 135 which injects the compressor refrigerant into the target heat exchanger, where it expands. In this instance, the compressor refrigerant can absorb thermal energy from the target fluid.

The natural circulation refrigerant system 140 comprises the intermediate heat exchange 120, which thermally connects the compressor refrigerant system and the natural circulation refrigerant system 140. The compressor refrigerant and the natural circulation refrigerant are spatially separated and are not mixed. The natural circulation refrigerant system 140 is configured to discharge the thermal energy, which the natural circulation refrigerant absorbs in the intermediate heat exchanger 120, to the environment.

The natural circulation refrigerant system 140 comprises upstream of the intermediate heat exchanger 120 an ambient air condenser 145 which cools and liquefies the natural circulation refrigerant by means of ambient air. Natural circulation refrigerant which is cooled and liquefied in the ambient air condenser can be injected into the intermediate heat exchanger.

The ambient air condenser 145 comprises a fan 150 in order to control a cooling power of the ambient air condenser 145.

A control valve 165 is arranged downstream of the ambient air condenser 145 in order to control a mass flow of the natural circulation refrigerant in the intermediate heat exchanger 120. The control valve 165 can be controlled by means of a control unit 175 and an actuator 170. The actuator 170 can be controlled by means of the control unit 175 and can control a degree of opening of the control valve 165.

An exchange heat which can be discharged in the intermediate heat exchanger from the compressor refrigerant to the natural circulation refrigerant is limited by the mass flow of the natural circulation refrigerant in the intermediate heat exchanger. A condensation pressure of the compressor refrigerant describes the pressure at which the compressor refrigerant is liquefied in the intermediate heat exchanger. The condensation pressure of the compressor refrigerant can be controlled by means of the exchange heat. The condensation pressure of the compressor refrigerant can be controlled by means of a mass flow of the natural circulation refrigerant in the intermediate heat exchanger. The condensation pressure of the compressor refrigerant can be influenced by means of the control valve, in particular via a degree of opening of the control valve. The pressure sensor 130 may be connected to the control unit 175 in a control circuit. The control unit 175 may control the degree of opening of the control valve 165 in accordance with the data of the pressure sensor 130, in particular in order to keep the condensation pressure as far as possible constant at a target condensation pressure which is predetermined for the control circuit.

A parallel-connected refrigerant system 160 is integrally connected to the natural circulation refrigerant system 140 or integrated therein. The refrigerant in the parallel-connected refrigerant system is the same refrigerant as in the natural circulation refrigerant system, that is to say, it is the natural circulation refrigerant. The parallel-connected refrigerant system comprises a parallel-connected control valve 165 which is arranged downstream of the ambient air condenser. A mass flow of the natural circulation refrigerant in the parallel-connected refrigerant system 160 can be controlled by means of the parallel-connected control valve 167 or the degree of opening thereof by means of a parallel-connected actuator 172. The control unit 175 controls the parallel-connected actuator 172.

The parallel-connected refrigerant system uses the ambient air condenser 145. The target fluid is cooled with a parallel-connected cooling power 185 of the refrigeration plant. The parallel-connected refrigerant system 160 comprises a parallel-connected heat exchanger 180 through which natural circulation refrigerant flows at the cold side. The parallel-connected heat exchanger 180 is connected at the hot side to the system which is intended to be cooled. In the parallel-connected heat exchanger 180, the natural circulation refrigerant absorbs thermal energy from the target fluid. The natural circulation refrigerant which has absorbed thermal energy from the target fluid in the parallel-connected heat exchanger 180 is liquefied in the ambient air condenser.

The natural circulation refrigerant system 140 can be constructed or operated without a compressor or pump. The height difference 190 between the intermediate heat exchanger 120 and the ambient air condenser 145 is 0.5 m or more typically 1 m or more. In the natural circulation refrigerant system, consequently, a thermosiphon is produced. The parallel-connected height difference 195 between the parallel-connected heat exchanger 180 and the ambient air condenser 145 is 1 m, but may also be greater. A thermosiphon is consequently produced in the parallel-connected refrigerant system 160. Typically, the height differences between the respective upper connections or the respective lower connections of the respective heat exchangers are measured.

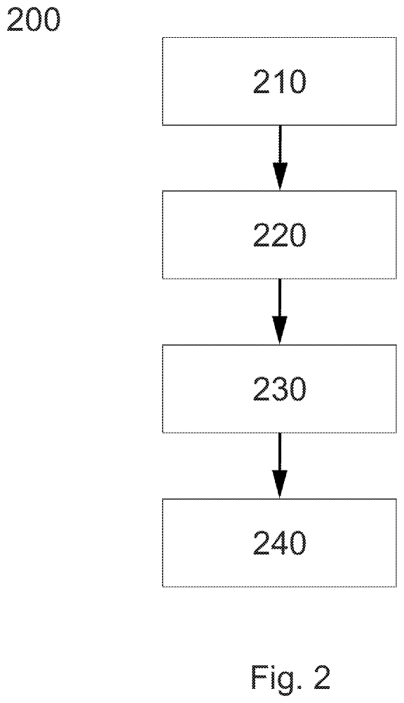

In FIG. 2, a method for cooling a target fluid using a refrigeration plant as described herein is illustrated. A method for cooling the target fluid via the compressor refrigerant system is illustrated.

In step 210, the refrigeration plant is started. To this end, the parallel-connected control valve and the control valve are closed and the compressor is started. The intermediate heat exchanger is not flowed through by the natural circulation refrigerant and is rapidly heated by the compressed compressor refrigerant. As a result of the heating of the intermediate heat exchanger, the condensation pressure of the compressor refrigerant increases. After reaching the target condensation pressure, the control valve is opened and by controlling the exchange heat which is discharged in the intermediate heat exchanger, the condensation pressure of the compressor refrigerant is controlled to the target condensation pressure.

In the following step 220, the refrigeration plant is operational. If there is a requirement to increase a useful cooling power of the refrigeration plant, in typical embodiments the throttle valve can be opened further so that more compressor refrigerant is injected into the target heat exchanger. In order to inject more compressor refrigerant into the target heat exchanger, more compressor refrigerant has to be liquefied in the intermediate heat exchanger. In order to liquefy the additional compressor refrigerant in the intermediate heat exchanger, a degree of opening of the control valve can be increased in typical embodiments in order to convey more natural circulation refrigerant through the intermediate heat exchanger. The compressor refrigerant can then discharge more exchange heat to the natural circulation refrigerant.

In typical embodiments, there is typically a requirement to increase or decrease the useful cooling power from a control which monitors the temperature of the target fluid after flowing though the target heat exchanger.

If there is a requirement to increase the useful cooling power even further, in a step 230 by switching on the fan of the ambient air condenser the natural circulation refrigerant can discharge more exchange heat to the ambient air. The natural circulation refrigerant can absorb more exchange heat from the compressor refrigerant.

The speed of the fan is controlled in accordance with the condensation pressure in order to increase or decrease the discharged quantity of exchange heat in accordance with a requested useful cooling power. At maximum operation of the fan, the control valve can be opened further or opened completely (step 240). More natural circulation refrigerant flows into the intermediate heat exchanger. The compressor refrigerant can discharge more exchange heat to the natural circulation refrigerant. The exchange heat is maximized. The useful cooling power of the refrigeration plant is maximized.

When a required useful cooling power is reduced or when the condensation pressure falls, in typical embodiments the above-mentioned steps are each carried out in the reverse order in order to accordingly adapt the useful cooling power of the refrigeration plant.

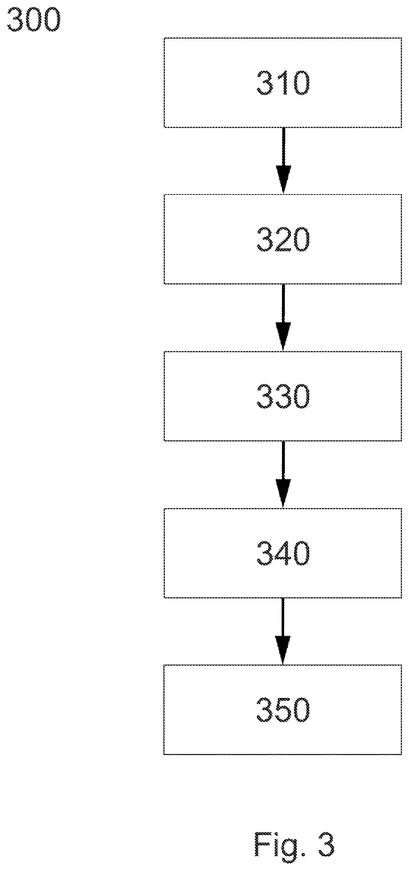

In FIG. 3, a method for cooling a target fluid using a refrigeration plant as described herein is illustrated. A method for cooling the target fluid via the parallel-connected refrigerant system is illustrated.

In step 310, it is verified whether free cooling via the parallel-connected refrigerant system is possible. To this end, it is verified whether the ambient temperature of the ambient air is below the target temperature and, if so, a temperature difference between the target temperature of the target fluid and the ambient temperature of the ambient air is compared with a limit temperature difference. If the temperature difference exceeds the limit temperature difference, cooling via the parallel-connected refrigerant system is possible.

If cooling is possible via the parallel-connected refrigerant system, the refrigeration plant is switched in step 320 to cooling via the parallel-connected refrigerant system. The control valve is closed and the parallel-connected control valve is opened. The natural circulation refrigerant flows through the parallel-connected heat exchanger and absorbs a parallel-connected exchange heat from the target fluid. The target fluid is cooled. The parallel-connected cooling power is dependent on the parallel-connected exchange heat.

In the following step 330, a refrigeration plant is operational. If there is a requirement to increase a parallel-connected cooling power of the refrigeration plant, in typical embodiments a degree of opening of the parallel-connected control valve can be increased so that more natural circulation refrigerant is conveyed through the parallel-connected heat exchanger. The target fluid can discharge more exchange heat to the natural circulation refrigerant.

If there is a requirement to further increase a parallel-connected cooling power, in a step 340 by switching on a fan of an ambient air condenser the natural circulation refrigerant can discharge more exchange heat to ambient air. The natural circulation refrigerant can absorb more exchange heat from the target fluid.

The speed of the fan is typically controlled in accordance with the condensation pressure in order to increase or decrease the discharged quantity of exchange heat in accordance with a required parallel-connected cooling power.

In the following step 350, at maximum operation of the fan the parallel-connected control valve can be opened further. The parallel-connected control valve can be completely opened. More natural circulation refrigerant flows into the parallel-connected heat exchanger. The target fluid can discharge more exchange heat to the natural circulation refrigerant. The exchange heat is maximized. The parallel-connected cooling power of the refrigeration plant is maximized.

When a required useful cooling power is reduced or when a condensation pressure falls, in typical embodiments the above-mentioned steps are carried out in each case in the reverse order in order to accordingly adapt the useful cooling power of the refrigeration plant.

1. A refrigeration plant (100) for cooling a target fluid to a target temperature between −80° C. and +30° C. by means of ambient air,
comprising a compressor refrigerant system (105) having a compressor (125) and a target heat exchanger (120) for cooling the target fluid;
further comprising a natural circulation refrigerant system (140) having an ambient air condenser (145) and a control valve (165),
and having an intermediate heat exchanger (120) which couples the natural circulation refrigerant system (140) to the compressor refrigerant system (105).

2. The refrigeration plant according to claim 1, wherein the compressor refrigerant system (105) comprises a pressure sensor (130) for establishing a pressure of a compressor refrigerant which is located in the compressor refrigerant system (105).

3. The refrigeration plant according to claim 1, wherein the control valve (165) is configured in a supply line to the intermediate heat exchanger (120) so that the supply of a natural circulation refrigerant of the natural circulation refrigerant system (140) to the intermediate heat exchanger (120) can be controlled.

4. The refrigeration plant according to claim 2, wherein the ambient air condenser (145) comprises a fan (150) which is configured to convey ambient air through the ambient air condenser (145) in order to increase a cooling power of the ambient air condenser (145).

5. The refrigeration plant according to claim 1, wherein the ambient air condenser (145) is arranged higher than the intermediate heat exchanger (120).

6. The refrigeration plant according to claim 1, wherein the natural circulation refrigerant system (140) has a parallel-connected refrigerant system (160), comprising:
a parallel-connected heat exchanger (180) for cooling the target fluid, and
a parallel-connected control valve (167) for controlling the supply flow to the parallel-connected heat exchanger (180);
wherein the parallel-connected refrigerant system (160) is connected to the ambient air condenser (145) of the natural circulation refrigerant system (140).

7. The refrigeration plant according to claim 6, wherein the parallel-connected control valve (167) is configured in such a manner that it controls the supply of the natural circulation refrigerant from the natural circulation refrigerant system (140) into the parallel-connected refrigerant system (160).

8. A method for cooling a target fluid to a target temperature between −80° C. and +30° C. by means of ambient air using a refrigeration plant (100) according to claim 1.

9. The method according to claim 8, wherein, in order to start the refrigeration plant (100), the following steps are carried out in the sequence set out:
closing the control valve (165) and closing the parallel-connected control valve (167);
switching on the compressor (130) in order to condense the compressor refrigerant so that the intermediate heat exchanger is heated by means of the compressor refrigerant;
establishing a pressure of the compressor refrigerant downstream of the compressor (130), upstream of the intermediate heat exchanger, and comparing the pressure with a target pressure; and
opening the control valve (165) when the pressure of the compressor refrigerant reaches the target pressure.

10. The method according to claim 8, comprising opening the control valve (165) until a degree of opening of the control valve reaches a first limit value, wherein the degree of opening is dependent on the pressure of the compressor refrigerant.

11. The method according to claim 10, further comprising, after reaching the first limit value, increasing a speed of a fan (150) of the ambient air condenser (145) up to a limit speed, wherein the speed is dependent on the pressure of the compressor refrigerant.

12. The method according to claim 11, further comprising, after reaching the limit speed, increasing the degree of opening of the control valve (165) up to a second limit value, wherein the speed is dependent on the pressure of the compressor refrigerant.

13. The method according to claim 8, comprising closing the control valve (165) and opening the parallel-connected control valve (167) when a limit temperature difference which represents a difference between the target temperature and the ambient air temperature is exceeded.

14. The method according to claim 13, wherein the limit temperature difference is at least 5 K.

15. The method according to claim 8, comprising controlling a mass influx of the natural circulation refrigerant from the natural circulation refrigerant system (140) into the parallel-connected refrigerant system (160) by controlling the parallel-connected control valve (167).
